(19) United States
(12) Patent Application Publication
(10) Pub. No.: US 2024/0163758 A1
(43) Pub. Date: May 16, 2024

(54) SUPPORT OF PARTIAL MIGRATION OF A MOBILE NODE

(71) Applicant: QUALCOMM Incorporated, San Diego, CA (US)

(72) Inventors: Naeem AKL, Bridgewater, NJ (US); Karl Georg HAMPEL, Jersey City, NJ (US)

(21) Appl. No.: 18/490,049

(22) Filed: Oct. 19, 2023

Related U.S. Application Data
(60) Provisional application No. 63/383,911, filed on Nov. 15, 2022.

(51) Int. Cl. H04W 36/08

(52) U.S. Cl. CPC H04W 36/087

(57) ABSTRACT

Certain aspects of the present disclosure provide techniques for method of wireless communication at a first centralized unit (CU) generally including receiving, from a second CU having a connection to an integrated access and backhaul (IAB) mobile termination (IAB-MT) of an IAB node, a first identifier of the IAB-MT and a second identifier of a third CU; and transmitting, to the third CU, a request to perform a migration of transport of traffic of a IAB distributed unit (IAB-DU) of the IAB node via a topology of the third CU, wherein the request includes the first identifier.

### CROSS-REFERENCE TO RELATED APPLICATION

This application claims benefits of and priority to U.S. Provisional Patent Application No. 63/383,911, filed on Nov. 15, 2022, which is assigned to the assignee hereof and herein incorporated by reference in its entirety as if fully set forth below and for all applicable purposes.

### FIELD OF THE DISCLOSURE

Aspects of the present disclosure relate to wireless communications, and more particularly, to techniques for partial migration of a mobile node, such as an integrated access and backhaul (IAB) node.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communication at a first centralized unit (CU). The method includes receive, from a second CU having a connection to an integrated access and backhaul (IAB) mobile termination (IAB-MT), a first identifier of the IAB-MT and a second identifier of a third CU; and transmitting, to the third CU, a request to perform a migration of traffic of an IAB distributed unit (IAB-DU) via the third CU, wherein the request includes the first identifier and the IAB-MT and IAB-DU are co-located in an IAB node.

Another aspect provides a method of wireless communication at a second CU. The method includes establishing a connection for traffic of an IAB distributed unit (IAB-DU) of an IAB node via the second CU, wherein the IAB DU has a connection to a first CU; exchanging, with a third CU, a first identifier of an IAB mobile termination (IAB-MT) in preparation of a migration of the IAB-MT from the second CU to the third CU, wherein the IAB-MT and IAB-DU are co-located in an IAB node; and providing the first identifier to the first CU.

Another aspect provides a method of wireless communication at a third CU. The method includes exchanging, with a second CU, a first identifier of an integrated access and backhaul (IAB) mobile termination (IAB-MT), in preparation of a migration of the IAB-MT from the second CU to the third CU; and receiving, from a first CU, a request to migrate traffic of an IAB distributed unit (IAB-DU) to the third CU, wherein the request includes the first identifier and the IAB-MT and IAB-DU are co-located in an IAB node.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example radio access network (RAN) architecture.

FIG. 6 depicts an example of a centralized unit (CU) with a separation of control plane (CP) and user plane (UP) functionality.

FIGS. 7-9 depict examples of different IAB node migration scenarios.

FIG. 10 depicts a method for wireless communications.

FIG. 11 depicts a method for wireless communications.

FIG. 12 depicts a method for wireless communications.

FIG. 13 depicts aspects of an example communications device.

### DETAILED DESCRIPTION

Aspects of the present disclosure provide apparatuses, methods, processing systems, and computer-readable mediums for partial migration of a mobile node, such as an integrated access and backhaul (IAB) node.

IAB nodes can enhance coverage in wireless networks, effectively serving as wireless relays. In NR, IAB nodes support access (a link with a user equipment-UE) and backhauling (a link with a network entity). A terminating node of a backhaul link on network side is referred to as an IAB-donor. Backhauling can occur via a single or via multiple hops. An IAB-node supports gNB distributed unit (DU) functionality to terminate access interface to UEs and next-hop IAB-nodes, and to terminate the F1 protocol to the gNB centralized unit (CU) functionality on the IAB-donor. The gNB-DU functionality on the IAB-node is also referred to as IAB-DU.

In addition to the gNB-DU functionality, the IAB-node also supports a subset of the UE functionality referred to as an IAB mobile termination (IAB-MT). Such functionality includes, for example, physical layer (PHY), layer-2 (e.g., medium access control MAC), radio resource control (RRC), and non-access stratum (NAS) functionality to connect to the gNB-DU of another IAB-node or the IAB-donor, to connect to the gNB-CU on the IAB-donor, and to the core network.

IAB-nodes that are both connected to an IAB-donor via one or multiple backhaul hops and are controlled by this IAB-donor via an application protocol (AP) interface (FIAP) and/or RRC generally form an IAB topology with the IAB-donor as its root. In this IAB topology, a neighbor node of the IAB-DU or the IAB-donor-DU is typically referred to as a child node and a neighbor node of the IAB-MT is typically referred to as a parent node. The direction toward the child node is referred to as downstream while the direction toward the parent node is referred to as upstream. The IAB-donor performs centralized resource, topology and route management for its IAB topology.

IAB nodes may move from a first parent node to a second parent node, where some or all services provided by the first parent node prior are provided by the second parent node after the move, referred to herein as migration. For example, an IAB node can migrate to a different parent node underneath the same IAB-donor-CU. In such cases, the IAB-node continues providing access and backhaul service when migrating to a different parent node. The IAB-MT can also migrate to a different parent node underneath another IAB-donor-CU. In such cases, the collocated IAB-DU and the IAB-DU(s) of its descendant node(s) retain F1 connectivity with the initial IAB-donor-CU. The IAB-MT of each descendant node and all the served UEs retain the RRC connectivity with the initial IAB-donor-CU. This type of migration is referred to as inter-donor partial migration. After a partial migration, the F1 traffic of the IAB-DU and its descendant nodes is routed via the IAB topology to which the IAB-MT has migrated.

One potential challenge with partial migration is how to identify entities subject to migration (handover) between network entities. For example, after a first partial migration, from a first CU (CU1) to a second CU (CU2), a second partial migration may occur from CU2 to a third CU (CU3). In preparation of the second partial migration, CU2 may forward information, such as ID(s) to CU1. This information may be intended to help CU1 communicate with CU3 directly, in order to migrate the F1 traffic of the IAB-DU to the CU3 topology. Unfortunately, if CU1 contacts CU3 and provides the UE IDs (e.g., Xn AP ID(s)) that were previously allocated by CU1 and CU2, CU3 may not be able to identify the IAB-node for which F1 traffic should be migrated. This is because the UE XnAP ID(s) are typically specific to an interface between two gNB CUs.

Aspects of the present disclosure, however, may help address this potential challenge. For example, an IAB-MT source donor (e.g., CU2 in the example above) may also forward the IAB-MT ID(s) allocated between the IAB-DU donor (e.g., CU1 in the example above) and the IAB-MT source donor (CU2) to the IAB-MT target donor (e.g., CU3 in the example above). As a result, the IAB-DU donor (CU1) and the IAB-MT target donor (CU3) may be able to communicate directly, facilitating the second migration of traffic (via the CU3 topology).

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

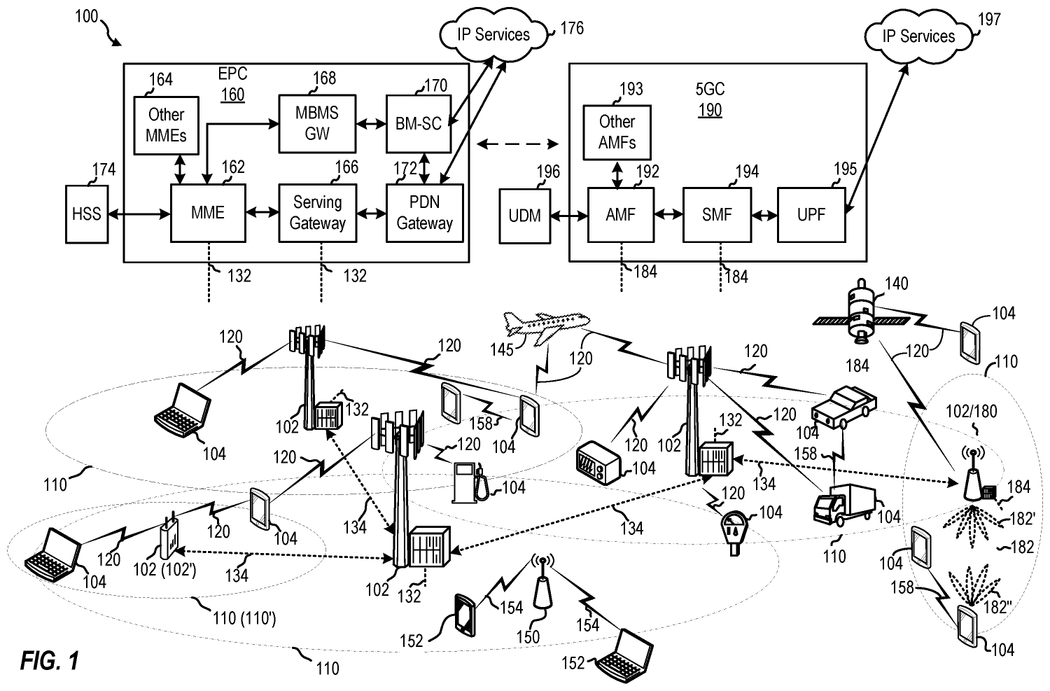

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BS s 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

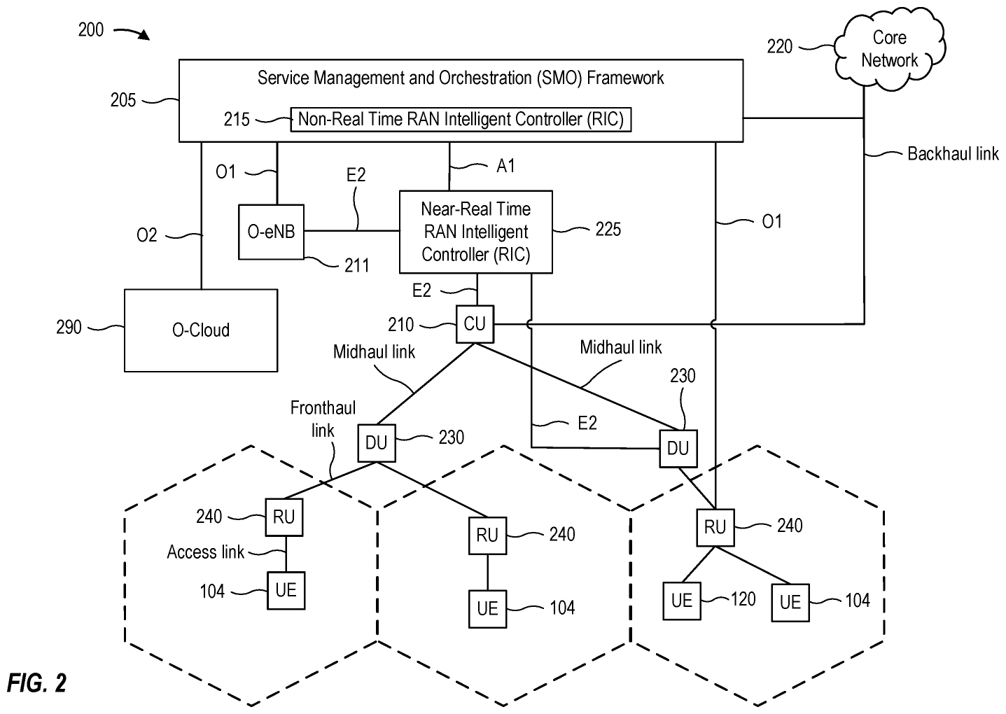

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BS s 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

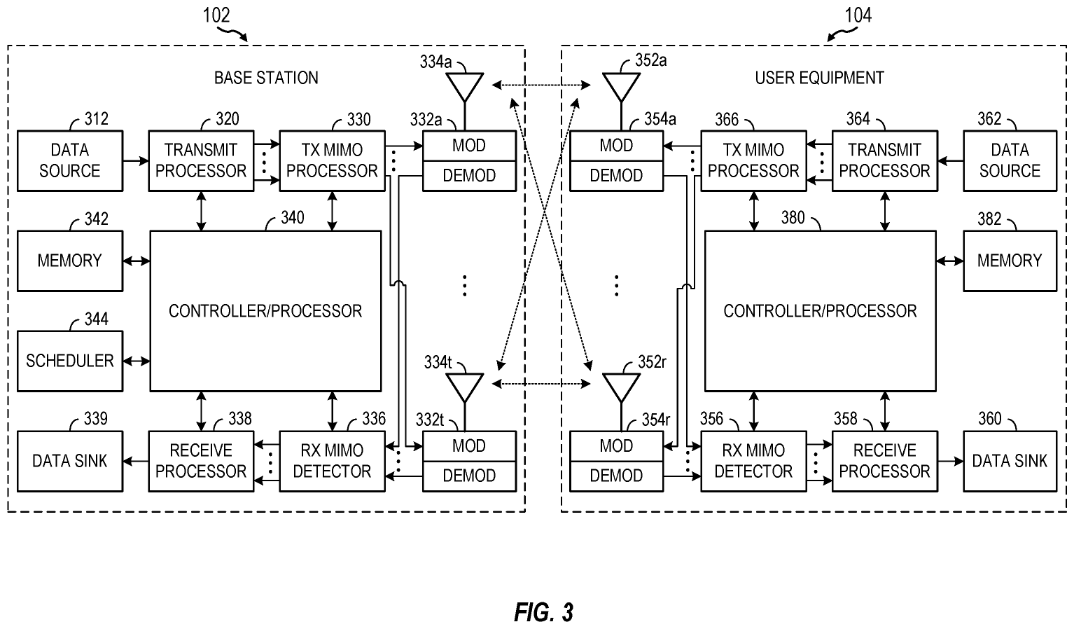

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

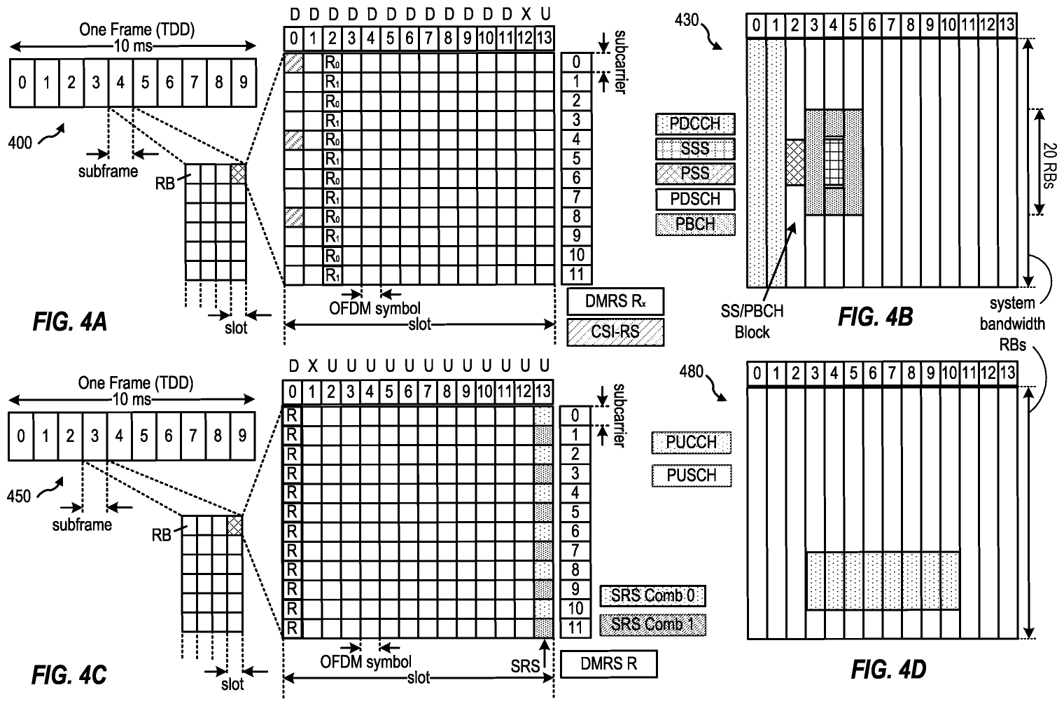

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIB s), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of a RAN Architecture

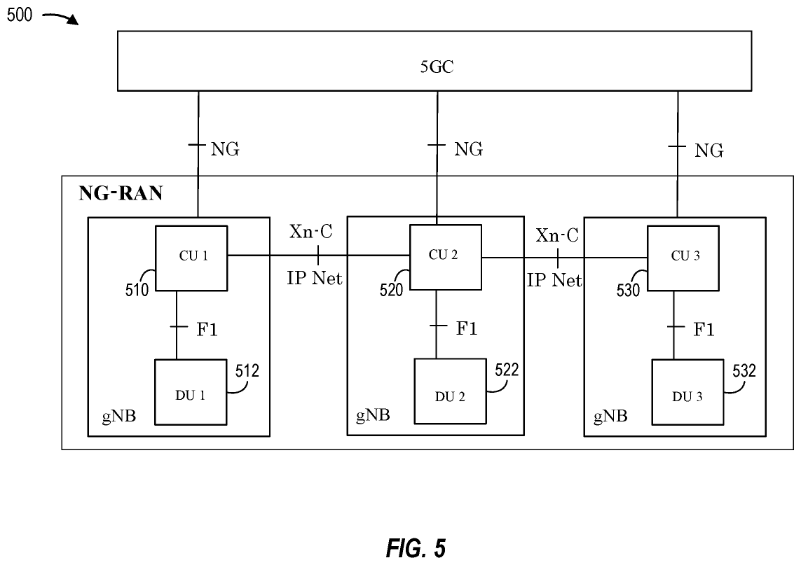

FIG. 5 illustrates an example architecture 500 of a radio access network (e.g., a NG-RAN). A gNB Central Unit (gNB-CU) 510 generally acts as a logical node hosting RRC, SDAP and PDCP protocols of the gNB that controls the operation of one or more gNB-DUs. The gNB-CU terminates the F1 interface connected with the gNB-DU.

A gNB Distributed Unit (gNB-DU) 530 generally acts as a logical node hosting RLC, MAC and PHY layers of the gNB, and its operation is controlled by gNB-CU. One gNB-DU may support one or multiple cells, while one cell is typically supported by only one gNB-DU. As illustrated, the gNB-DU terminates the F1 interface connected with the gNB-CU.

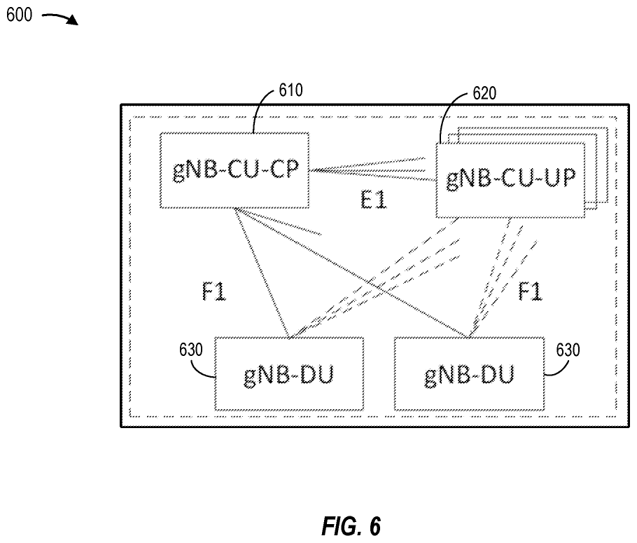

FIG. 6 illustrates an example architecture 600 with a separation of the gNB-CU control plane (gNB-CU-CP) and the gNB-CU user plane (gNB-CU-UP) functionality. A gNB may include a gNB-CU-CP 510_{CP}, multiple gNB-CU-UPs 510_{UP} and multiple gNB-DUs 530.

As illustrated, the gNB-CU-CP may be connected to the gNB-DU through the F1-C interface. The gNB-CU-UP may be connected to the gNB-DU through the F1-U interface. The gNB-CU-UP may be connected to the gNB-CU-CP through the E1 interface.

One gNB-DU may be connected to only one gNB-CU-CP and one gNB-CU-UP may be connected to only one gNB-CU-CP. On the other hand, one gNB-DU can be connected to multiple gNB-CU-UPs under the control of the same gNB-CU-CP and one gNB-CU-UP can be connected to multiple DUs under the control of the same gNB-CU-CP.

### Overview of Partial Migrations

As noted above, IAB nodes can enhance coverage in wireless networks, effectively serving as wireless relays. In NR, IAB nodes support access (a link with a user equipment-UE) and backhauling (a link with a network entity).

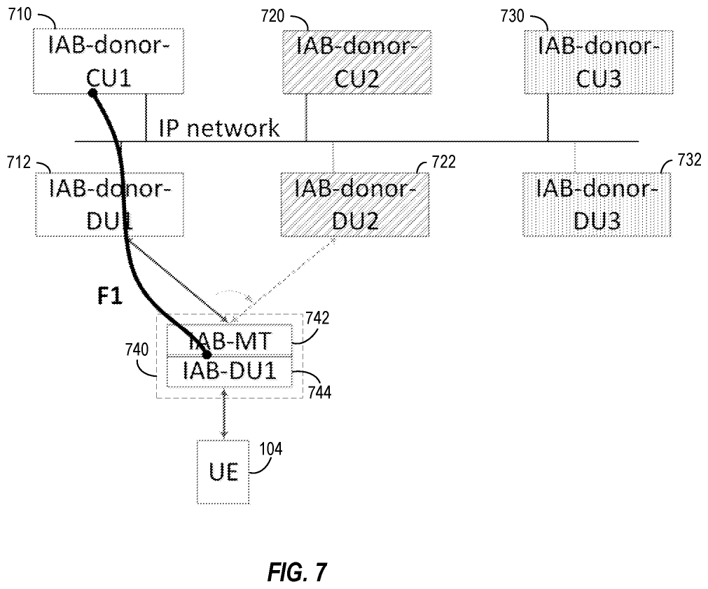

As illustrated in the example scenario in FIG. 7, a terminating node of a backhaul link of an IAB node 740 on the network side is referred to as an IAB-donor. In the illustrated example, an IAB-MT 742 of the IAB node 740 is connected to IAB-donor DU1 712 while IAB-DU1 744 of the IAB node 740 is connected to an IAB-donor CU1 710. IAB-DU1 744 generally refers to the gNB-DU functionality on the IAB-node 740.

As previously noted, migration generally refers to scenario where some or all services provide to a child node by one parent node are moved or transferred to another parent node, such that the other parent node provides such services after the migration. Cases where some, but not all services, are transferred is referred to herein as a partial migration. For example, when IP connectivity between target IAB-donor DU and source IAB-donor CU is available, and when Xn connectivity between source and target donor CU is available, a partial migration may be used for supporting the F1 transport migration and inter-donor routing when an IAB-DU and its co-located IAB-MT (e.g., of a mobile IAB) are connected to different donor CUs.

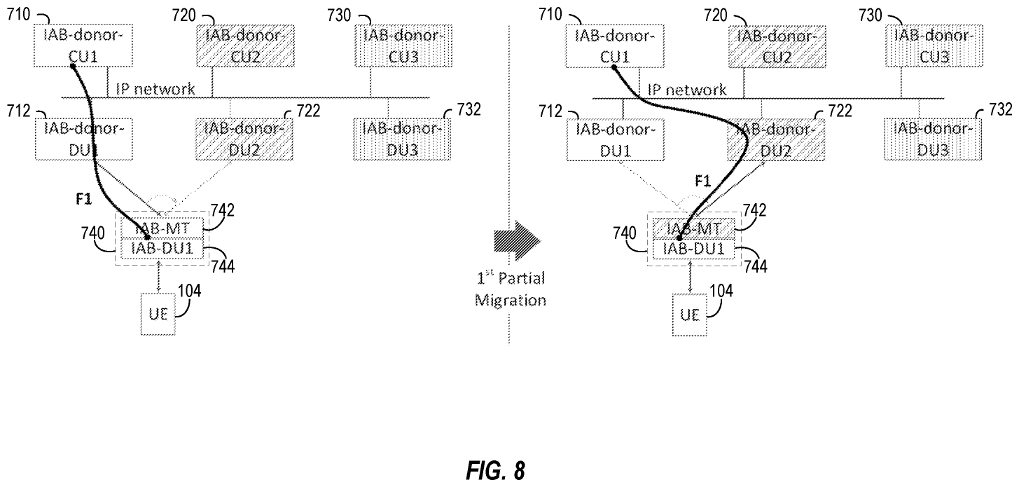

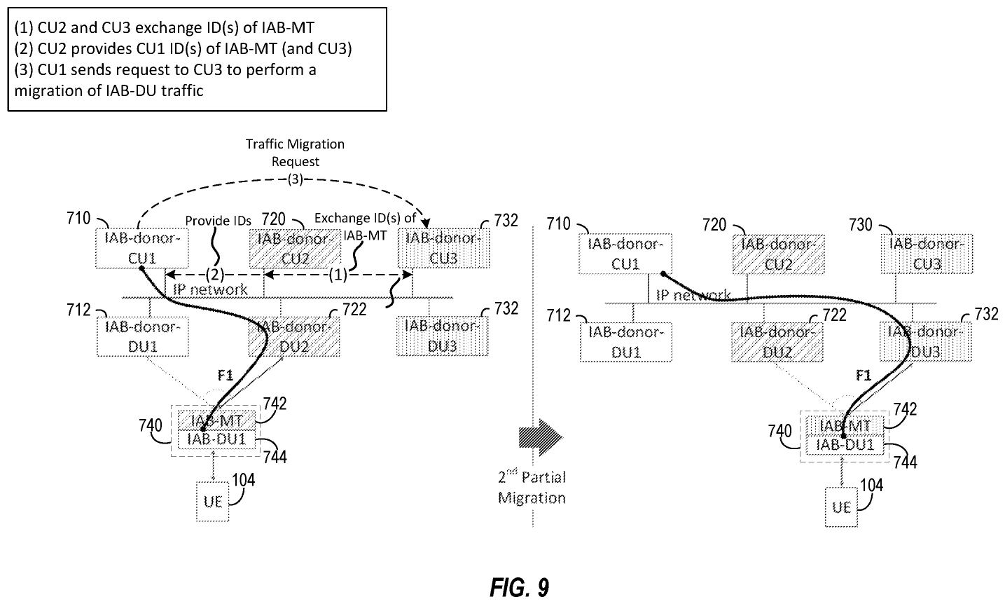

As will be described with reference to FIG. 8 and FIG. 9, the IAB-node may perform multiple consecutive partial migrations without inter-donor migration of its mobile IAB-DU. In this manner, an IAB-MT may perform multiple consecutive inter-donor handovers (HOs), while the IAB-DU remains connected to the initial IAB-donor. For such inter-donor partial migration, the donor CU serving the IAB-DU may be informed about an IAB-MT HO. In some cases, the source donor CU for the IAB-MT HO may provide to the donor CU serving the IAB-DU various information. This information may include, for example, one or more of: the gNB ID of the target donor CU for the IAB-MT HO, and ID(s) of the IAB-MT.

### Aspects Related to Support of Partial Migration of an IAB Node

Aspects of the present disclosure provide apparatuses, methods, processing systems, and computer-readable mediums for partial migration of a mobile node, such as an integrated access and backhaul (IAB) node. As used herein, the term migration may refer to various procedures, including a handover, a secondary node (SN) change, or a radio link failure (RLF) recovery.

The signaling techniques proposed herein may be used, for example, in a scenario where an IAB node, such as a mobile IAB node (mIAB), is involved in one or more partial migrations. While the terms IAB and mIAB may be used interchangeably herein, the techniques proposed herein can more generally be applied to any type of IAB (e.g., whether stationary or mobile). As noted above, a partial migration generally results in an IAB-MT connected to one CU and an IAB-DU connected to another CU. The techniques described herein may help the CU with the IAB-DU connection communicate with a third CU, that is an IAB-MT target donor of a migration (which could be performed after a previous partial migration to a second CU), in order to route traffic via the topology of the third CU.

In some scenarios, there may be multiple IAB-DUs on an IAB-node (e.g., multiple CU1s). The signaling techniques proposed herein may apply to such a scenario, for example, where CU2 talks to each of the CU1s about CU3, or CU2 talks to CU3 about each of the CU1s, or each of the CU1s contacts CU3.

The signaling techniques proposed herein may be understood with reference to FIGS. 8 and 9 which illustrate example partial migrations, assuming the initial state shown in FIG. 7 in which the IAB-MT 742 of an IAB node 740 is connected to a first IAB donor, IAB-donor-DU1 712 and IAB-DU1 744 is connected to IAB-donor-CU1 710.

As illustrated in FIG. 8, after a first partial migration, the IAB-MT 742 may be connected to a second IAB donor, IAB-Donor-DU2 722, under control of a second CU, CU2 720. As illustrated in FIG. 9, after a second partial migration, the IAB-MT 742 may be connected to a third IAB-donor-DU3 732, under control of a third CU, CU3 730.

As illustrated, after each partial migration, the collocated IAB-DU and the IAB-DU(s) of its descendant node(s) retain F1 connectivity with the initial IAB-donor-CU. The IAB-MT of each descendant node and all the served UEs retain the RRC connectivity with the initial IAB-donor-CU. After a partial migration, the F1 traffic of the IAB-DU and its descendant nodes (if any) is routed via the CU topology to which the IAB-MT has migrated.

In preparation of a partial migration, such as the second partial migration shown in FIG. 9, CU2 may forward information such as ID(s) to CU1. This information may be intended to help CU1 communicate with CU3 directly, in order to migrate the F1 traffic of the IAB-DU to the CU3 topology.

Unfortunately, if CU1 contacts CU3 and provides the UE IDs (e.g., Xn AP ID(s)) that were previously allocated by CU1 and CU2, CU3 may not be able to identify the IAB-node for which F1 traffic should be migrated. This is because the UE XnAP ID(s) are typically interface specific between two gNB CUs.

Aspects of the present disclosure, however, may help address this potential challenge. In some cases, a second CU may establish transport of traffic of an IAB-DU of an IAB node via a topology of the second CU, wherein the IAB DU has a connection to a first CU. For example, this may occur after a previous partial migration of the IAB-MT of the IAB node from the first CU to the second CU. The second CU may then exchange, with a third CU, a first ID of the IAB-MT of the IAB node, in preparation of a migration of the IAB-MT from the second CU to the third CU. The second CU may then provide the first ID to the first CU.

An example of this signaling is shown in FIG. 9. As illustrated, IAB-donors CU2 and CU3 may exchange one or more IDs of the IAB-MT, at (1). IAB-donor-CU2 may then provide the ID(s) of the IAB-MT to IAB-donor-CU1, at (2). In some cases, IAB-donor-CU2 may also provide IAB donor-CU1 with an ID of IAB-donor-CU3. As shown at (3), using the ID of the IAB-MT, IAB-donor-CU1 may then send a request to IAB-donor-CU3 to perform a request to perform a migration of transport of traffic of the IAB-DU of the IAB node via a topology of CU3. In some cases, CU3 may acknowledge the request and perform one or more actions for the migration (e.g., setting up transport, providing L2 info for the transport of the IAB-DU traffic, and the like).

In one example, CU1 and CU2 allocate ID(s) for the IAB-MT, for example, during a migration of the IAB-MT between CU1 and CU2. In this case, these IDs may be shared by CU2 with CU3. Upon sending the request for traffic migration from CU1 to CU3, CU1 may include these IDs in the request. As a result, CU3 is then able to identify the IAB-node.

In one example, CU2 and CU3 allocate ID(s) for the IAB-MT, for example, during a migration of the IAB-MT between CU2 and CU3. In this case, these IDs may be shared by CU2 with CU1. Again, upon sending the request for traffic migration from CU1 to CU3, CU1 may include these IDs in the request, allowing CU3 is then able to identify the IAB-node.

In one example, CU1 transmits the request for traffic migration to CU3, based on CU1 receiving the ID of CU3 from CU2. CU1 may include the ID of CU2 in the request, together with the IAB-MT ID(s). Based on inclusion of both IDs into the request, and based on a prior exchange of the IAB-MT ID(s) with CU2, CU3 is able to associate the request for traffic migration via the CU3 topology with the IAB-node and perform the one or more actions for the migration as listed above.

In one example, CU2 may provide the ID of CU1 to CU3 together with the IAB-MT ID(s). In this case, CU1 may transmit the request for traffic migration to CU3, based on receiving the ID of CU3 from CU2 and may include the IAB-MT ID(s) in the request. Based on receiving the ID of CU1 from CU2 together with the IAB-MT ID(s), and based on receiving the request from CU1 also including the IAB-MT ID(s), CU3 is able to associate the request for traffic migration via the topology of CU3 with the IAB-node and perform the one or more actions for the migration as listed above.

An IAB-MT source donor (e.g., CU2) can forward the IAB-MT ID(s) allocated between the IAB-DU donor (CU1) and the IAB-MT source donor (CU2) to the IAB-MT target donor. In some cases, CU2 and CU3 (or CU1 and CU2) allocate IAB-MT ID(s), such as UE XNAP ID(s), as part of HO (partial migration) preparation of the IAB-MT (e.g., between CU2 and CU3). CU2 may share these ID(s) with CU1 or CU3. As noted above, CU1 may contact CU3 and include the IAB-MT ID(s) received from CU2 as noted above, along with an ID of CU2.

An identifier of an IAB-MT may take various forms. For example, an IAB-MT may be one or a combination of a UE XnAP ID, a pair of UE XnAP IDs, or a Backhaul Adaptation Protocol (BAP) address or an ID of a serving cell of the IAB-MT. Similarly, an identifier of a CU may take various forms. For example, an identifier of a CU may be one or a combination of a gNB-ID, a RAN Node ID, or a topology identifier.

An IP address of an IAB-MT target donor may be acquired for the IAB-MT migration. For example, this may be acquired via a Transport Network Layer (TNL) address via a self-organizing network (SON) configuration transfer. For stationary networks, Xn procedures are typically confined to the local neighbour, such that only a few neighbour IP addresses need to be known by each gNB. Because an IAB (e.g., a mobile IAB) can perform a sequence of partial migrations, Xn connectivity between the IAB-DU donor and IAB-MT donor may span significant distances. In such cases, pre-configuration of IP addresses may not be scalable or convenient.

In case a donor does not have the IP address of a peer donor, the donor may use a self-organizing network (SON) Configuration Transfer procedure to retrieve this IP address. There may be no need to introduce an additional procedure for the exchange of Xn IP addresses.

In a SON Configuration Transfer, an IE may include configuration information used by SON functionality and may include an NG-RAN node identifier of the destination of this configuration information and the NG-RAN node identifier of the source of this information. An NG-RAN node may receive, in a SON Configuration Transfer IE, the SON Information IE containing the SON Information Reply IE including the Xn TNL Configuration Info IE as an answer to a former request. The NG-RAN node may then use this information to initiate an Xn TNL establishment.

In some cases, to apply the SON Configuration Transfer procedure, both a global NG-RAN ID and a tracking area identity (TAI) may be used. For a partial migration, according to aspects of the present disclosure, the source donor CU for the IAB-MT HO may provide to the donor CU serving the IAB-DU at least the gNB ID of the target donor CU for the IAB-MT HO. In such cases, the IAB-DU donor TAI may be lacking. According to aspects of the present disclosure, however, the IAB-MT source donor may provide the IAB-DU donor with a TAI or type allocation code (TAC) associated with the IAB-MT HO. This could be, for example, the TAI or TAC of target cell for the IAB-MT HO.

In some cases, an NG-RAN may provide an additional user location information (ULI). For example, based on a Mobile Base Station Relay (MBSR), such as an mIAB node, MBSR donor gNB information, together with an existing ULI, may be provided to an access and mobility management function (AMF), when a UE connects to the 5GC via an MB SR. The additional ULI may include the TAI/NR cell global identity (CGI) selected by the IAB-Node when it is registered to the network. The AMF may use the additional ULI, together with the existing ULI, to apply the mobility management (e.g. Mobility restriction) and Warning Area List management for Public Warning System (PWS).

In some cases, user location information (ULI) may be included in an IE used to provide location information of the UE. There are various options for how to share an IAB-MT ULI in partial migration scenarios, for example, where the mIAB-MT and mIAB-DU are connected to different donors. In some cases, the UE may connect to the mIAB-DU cell, and, thus, becomes RRC connected to mIAB-DU donor. The mIAB-DU donor may provide the UE's AMF with the ULI of the UE and ULI of the mIAB-MT. The ULI of mIAB-MT may include the NR-CGI and TAI of the mIAB-MT serving cell.

According to certain aspects of the present disclosure, the mIAB-MT donor provides the ULI of the mIAB-MT to the mIAB-DU donor. In such cases, the ULI may include the TAI or TAC of the mIAB-MT serving cell or the NR CGI of the mIAB-MT serving cell. In such cases, the mIAB-MT donor may be the source donor or the target donor. As noted above, the techniques may apply to a single partial migration scenario (e.g., only one of the migrations shown in FIGS. 8 and 9).

### Example Operations of Centralized Units

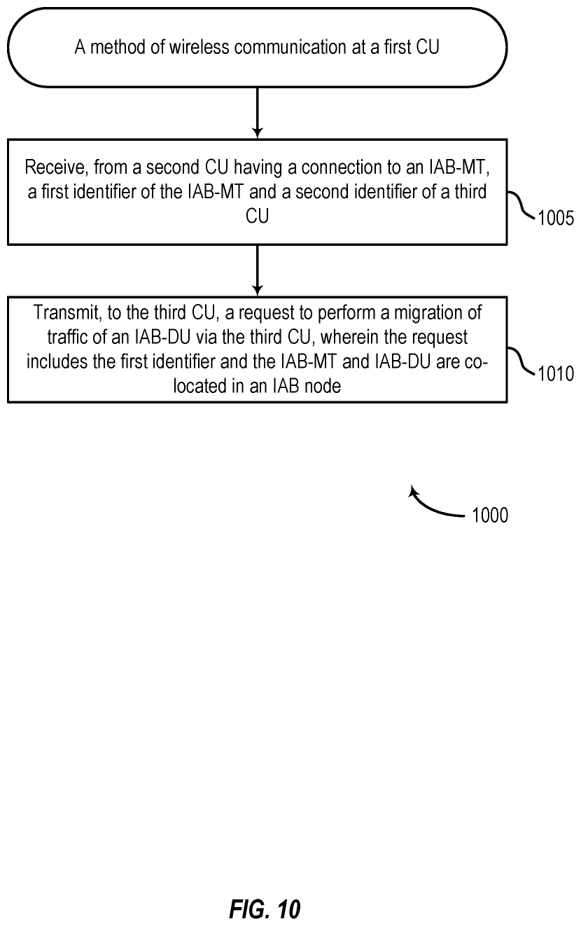

FIG. 10 shows an example of a method 1000 of wireless communication at a first CU, such as a BS 102 of FIGS. 1 and 3, or a disaggregated base station as discussed with respect to FIG. 2.

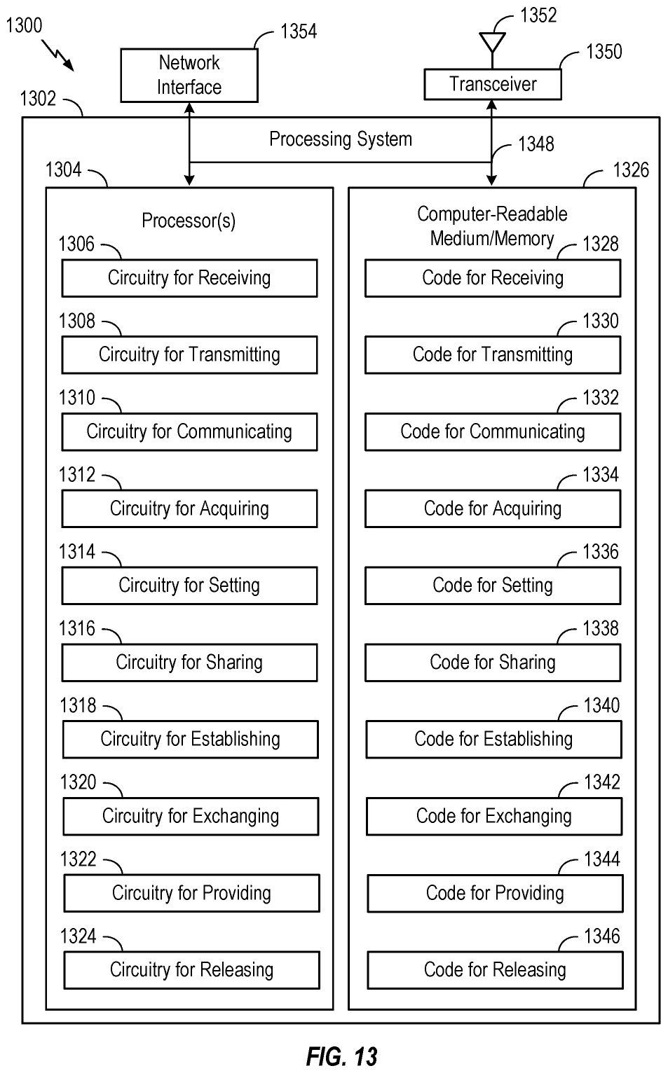

Method 1000 begins at step 1005 with receiving, from a second CU having a connection to an integrated access and backhaul (IAB) mobile termination (IAB-MT), a first identifier of the IAB-MT and a second identifier of a third CU. In some cases, the operations of this step refer to, or may be performed by, circuitry for receiving and/or code for receiving as described with reference to FIG. 13.

Method 1000 then proceeds to step 1010 with transmitting, to the third CU, a request to perform a migration of traffic of an IAB distributed unit (IAB-DU) via the third CU, wherein the request includes the first identifier and the IAB-MT and IAB-DU are co-located in an IAB node. In some cases, the operations of this step refer to, or may be performed by, circuitry for transmitting and/or code for transmitting as described with reference to FIG. 13.

In some aspects, the method 1000 further includes communicating with the IAB node, via a topology of the second CU. In some cases, the operations of this step refer to, or may be performed by, circuitry for communicating and/or code for communicating as described with reference to FIG. 13.

In some aspects, the method 1000 further includes receiving, from the third CU, an acknowledgment of the request. In some cases, the operations of this step refer to, or may be performed by, circuitry for receiving and/or code for receiving as described with reference to FIG. 13.

In some aspects, the first identifier is allocated between the first CU and the second CU in preparation of a prior migration of the IAB-MT from the first CU to the second CU.

In some aspects, the request also includes an identifier of the second CU.

In some aspects, the method 1000 further includes receiving, from at least one of the second CU or the third CU, at least one of a TAI or TAC associated with a migration of a connection of the IAB-MT from the second CU to the third CU. In some cases, the operations of this step refer to, or may be performed by, circuitry for receiving and/or code for receiving as described with reference to FIG. 13.

In some aspects, at least one of the TAI or TAC is associated with a target cell of the migration of the connection of the IAB-MT from the second CU to the third CU.

In some aspects, the method 1000 further includes receiving, from at least one of the second CU or the third CU, at least one of: an ID of a target cell of the second migration; or ULI of the IAB-MT. In some cases, the operations of this step refer to, or may be performed by, circuitry for receiving and/or code for receiving as described with reference to FIG. 13.

In some aspects, the method 1000 further includes acquiring a TNL address of the third CU via a SON configuration transfer. In some cases, the operations of this step refer to, or may be performed by, circuitry for acquiring and/or code for acquiring as described with reference to FIG. 13.

In some aspects, the method 1000 further includes setting up an interface for connectivity with the third CU using the TNL address. In some cases, the operations of this step refer to, or may be performed by, circuitry for setting and/or code for setting as described with reference to FIG. 13.

In some aspects, the method 1000 further includes sharing a ULI of the IAB-MT with an AMF of a UE connected to the IAB node. In some cases, the operations of this step refer to, or may be performed by, circuitry for sharing and/or code for sharing as described with reference to FIG. 13.

In one aspect, method 1000, or any aspect related to it, may be performed by an apparatus, such as communications device 1300 of FIG. 13, which includes various components operable, configured, or adapted to perform the method 1000. Communications device 1300 is described below in further detail.

Note that FIG. 10 is just one example of a method, and other methods including fewer, additional, or alternative steps are possible consistent with this disclosure.

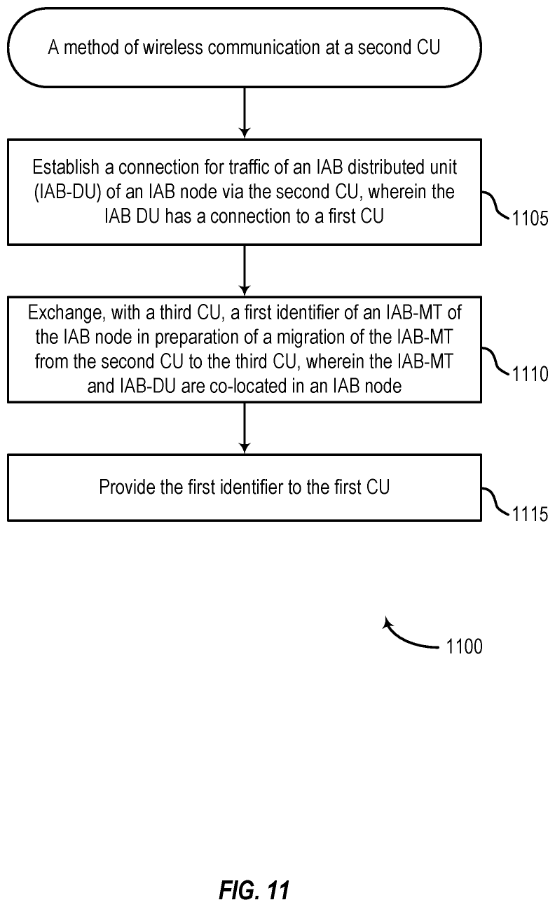

FIG. 11 shows an example of a method 1100 of wireless communication at a second CU, such as a BS 102 of FIGS. 1 and 3, or a disaggregated base station as discussed with respect to FIG. 2.

Method 1100 begins at step 1105 with establishing a connection for traffic of an IAB distributed unit (IAB-DU) of an IAB node via the second CU, wherein the IAB DU has a connection to a first CU. In some cases, the operations of this step refer to, or may be performed by, circuitry for establishing and/or code for establishing as described with reference to FIG. 13.

Method 1100 then proceeds to step 1110 with exchanging, with a third CU, a first identifier of an IAB mobile termination (IAB-MT) in preparation of a migration of the IAB-MT from the second CU to the third CU, wherein the IAB-MT and IAB-DU are co-located in an IAB node. In some cases, the operations of this step refer to, or may be performed by, circuitry for exchanging and/or code for exchanging as described with reference to FIG. 13.

Method 1100 then proceeds to step 1115 with providing the first identifier to the first CU. In some cases, the operations of this step refer to, or may be performed by, circuitry for providing and/or code for providing as described with reference to FIG. 13.

In some aspects, the method 1100 further includes releasing the transport of the traffic of the IAB-DU via a topology of the second CU. In some cases, the operations of this step refer to, or may be performed by, circuitry for releasing and/or code for releasing as described with reference to FIG. 13.

In some aspects, the first identifier is allocated between the second CU and the third CU in preparation of the migration.

In some aspects, the method 1100 further includes providing an identifier of the first CU to the third CU. In some cases, the operations of this step refer to, or may be performed by, circuitry for providing and/or code for providing as described with reference to FIG. 13.

In some aspects, the method 1100 further includes providing, to the first CU, at least one of a TAI or TAC associated with a second migration of a connection of the IAB-MT from the second CU to the third CU. In some cases, the operations of this step refer to, or may be performed by, circuitry for providing and/or code for providing as described with reference to FIG. 13.

In some aspects, at least one of the TAI or TAC is associated with a target cell of the second migration.

In some aspects, the method 1100 further includes providing, to the first CU, at least one of: an ID of a target cell of the second migration; or ULI of the IAB-MT. In some cases, the operations of this step refer to, or may be performed by, circuitry for providing and/or code for providing as described with reference to FIG. 13.

In one aspect, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative steps are possible consistent with this disclosure.

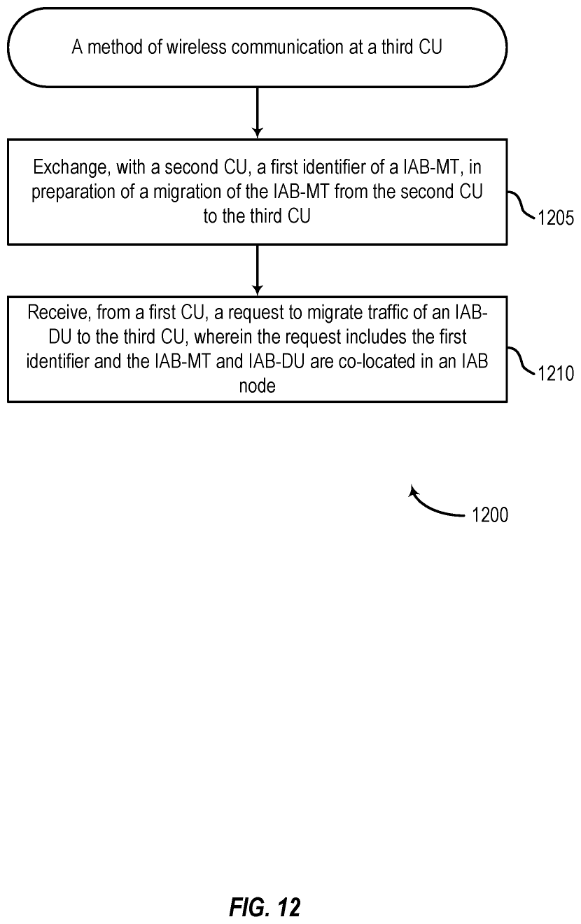

FIG. 12 shows an example of a method 1200 of wireless communication at a third CU, such as a BS 102 of FIGS. 1 and 3, or a disaggregated base station as discussed with respect to FIG. 2.

Method 1200 begins at step 1205 with exchanging, with a second CU, a first identifier of an integrated access and backhaul (IAB) mobile termination (IAB-MT), in preparation of a migration of the IAB-MT from the second CU to the third CU. In some cases, the operations of this step refer to, or may be performed by, circuitry for exchanging and/or code for exchanging as described with reference to FIG. 13.

Method 1200 then proceeds to step 1210 with receiving, from a first CU, a request to migrate traffic of an IAB distributed unit (IAB-DU) to the third CU, wherein the request includes the first identifier and the IAB-MT and IAB-DU are co-located in an IAB node. In some cases, the operations of this step refer to, or may be performed by, circuitry for receiving and/or code for receiving as described with reference to FIG. 13.

In some aspects, the first identifier is allocated between the first CU and the second CU in preparation of a previous migration.

In some aspects, the first identifier is allocated between the second CU and the third CU in preparation of the migration.

In some aspects, the request also includes an identifier of the second CU.

In some aspects, the method 1200 further includes receiving an identifier of the first CU from the second CU, prior to receiving the request from the first CU. In some cases, the operations of this step refer to, or may be performed by, circuitry for receiving and/or code for receiving as described with reference to FIG. 13.

In some aspects, the method 1200 further includes providing, to the first CU, at least one of a TAI or TAC associated with the migration. In some cases, the operations of this step refer to, or may be performed by, circuitry for providing and/or code for providing as described with reference to FIG. 13.

In some aspects, at least one of the TAI or TAC is associated with a target cell of the migration.

In some aspects, the method 1200 further includes providing, to the first CU, at least one of: an ID of a target cell of the migration; or ULI of the IAB-MT. In some cases, the operations of this step refer to, or may be performed by, circuitry for providing and/or code for providing as described with reference to FIG. 13.

In one aspect, method 1200, or any aspect related to it, may be performed by an apparatus, such as communications device 1300 of FIG. 13, which includes various components operable, configured, or adapted to perform the method 1200. Communications device 1300 is described below in further detail.

Note that FIG. 12 is just one example of a method, and other methods including fewer, additional, or alternative steps are possible consistent with this disclosure.

### Example Communications Device

FIG. 13 depicts aspects of an example communications device 1300. In some aspects, communications device 1300 is a CU, such as BS 102 of FIGS. 1 and 3, or a disaggregated base station as discussed with respect to FIG. 2.

The communications device 1300 includes a processing system 1305 coupled to the transceiver 1350 (e.g., a transmitter and/or a receiver) and/or a network interface 1354. The transceiver 1350 is configured to transmit and receive signals for the communications device 1300 via the antenna 1352, such as the various signals as described herein. The network interface 1354 is configured to obtain and send signals for the communications device 1300 via communication link(s), such as a backhaul link, midhaul link, and/or fronthaul link as described herein, such as with respect to FIG. 2. The processing system 1305 may be configured to perform processing functions for the communications device 1300, including processing signals received and/or to be transmitted by the communications device 1300.

The processing system 1305 includes one or more processors 1310. In various aspects, one or more processors 1310 may be representative of one or more of receive processor 338, transmit processor 320, TX MIMO processor 330, and/or controller/processor 340, as described with respect to FIG. 3. The one or more processors 1310 are coupled to a computer-readable medium/memory 1326 via a bus 1348. In certain aspects, the computer-readable medium/memory 1326 is configured to store instructions (e.g., computer-executable code) that when executed by the one or more processors 1310, cause the one or more processors 1310 to perform the method 1000 described with respect to FIG. 10, or any aspect related to it; the method 1100 described with respect to FIG. 11, or any aspect related to it; and the method 1200 described with respect to FIG. 12, or any aspect related to it. Note that reference to a processor of communications device 1300 performing a function may include one or more processors 1310 of communications device 1300 performing that function.

In the depicted example, the computer-readable medium/memory 1326 stores code (e.g., executable instructions), such as code for receiving 1328, code for transmitting 1330, code for communicating 1332, code for acquiring 1334, code for setting 1336, code for sharing 1338, code for establishing 1340, code for exchanging 1342, code for providing 1344, and code for releasing 1346. Processing of the code for receiving 1328, code for transmitting 1330, code for communicating 1332, code for acquiring 1334, code for setting 1336, code for sharing 1338, code for establishing 1340, code for exchanging 1342, code for providing 1344, and code for releasing 1346 may cause the communications device 1300 to perform the method 1000 described with respect to FIG. 10, or any aspect related to it; the method 1100 described with respect to FIG. 11, or any aspect related to it; and the method 1200 described with respect to FIG. 12, or any aspect related to it.

The one or more processors 1310 include circuitry configured to implement (e.g., execute) the code stored in the computer-readable medium/memory 1326, including circuitry such as circuitry for receiving 1306, circuitry for transmitting 1308, circuitry for communicating 1310, circuitry for acquiring 1312, circuitry for setting 1314, circuitry for sharing 1316, circuitry for establishing 1318, circuitry for exchanging 1320, circuitry for providing 1322, and circuitry for releasing 1324. Processing with circuitry for receiving 1306, circuitry for transmitting 1308, circuitry for communicating 1310, circuitry for acquiring 1312, circuitry for setting 1314, circuitry for sharing 1316, circuitry for establishing 1318, circuitry for exchanging 1320, circuitry for providing 1322, and circuitry for releasing 1324 may cause the communications device 1300 to perform the method 1000 described with respect to FIG. 10, or any aspect related to it; the method 1100 described with respect to FIG. 11, or any aspect related to it; and the method 1200 described with respect to FIG. 12, or any aspect related to it.

Various components of the communications device 1300 may provide means for performing the method 1000 described with respect to FIG. 10, or any aspect related to it; the method 1100 described with respect to FIG. 11, or any aspect related to it; and the method 1200 described with respect to FIG. 12, or any aspect related to it. Means for transmitting, sending or outputting for transmission may include transceivers 332 and/or antenna(s) 334 of the BS 102 illustrated in FIG. 3 and/or the transceiver 1350 and the antenna 1352 of the communications device 1300 in FIG. 13. Means for receiving or obtaining may include transceivers 332 and/or antenna(s) 334 of the BS 102 illustrated in FIG. 3 and/or the transceiver 1350 and the antenna 1352 of the communications device 1300 in FIG. 13.

### Example Clauses

Implementation examples are described in the following numbered clauses:

Clause 1: A method of wireless communication at a first CU, comprising: receiving, from a second CU having a connection to an integrated access and backhaul (IAB) mobile termination (IAB-MT), a first identifier of the IAB-MT and a second identifier of a third CU; and transmitting, to the third CU, a request to perform a migration of traffic of an IAB distributed unit (IAB-DU) via the third CU, wherein the request includes the first identifier and the IAB-MT and IAB-DU are co-located in an IAB node.

Clause 2: The method of Clause 1, further comprising: communicating with the IAB node, via a topology of the second CU.

Clause 3: The method of any one of Clauses 1 and 2, further comprising: receiving, from the third CU, an acknowledgment of the request.

Clause 4: The method of any one of Clauses 1-3, wherein the first identifier is allocated between the first CU and the second CU in preparation of a prior migration of the IAB-MT from the first CU to the second CU.

Clause 5: The method of any one of Clauses 1-4, wherein the request also includes an identifier of the second CU.

Clause 6: The method of any one of Clauses 1-5, further comprising: receiving, from at least one of the second CU or the third CU, at least one of a TAI or TAC associated with a migration of a connection of the IAB-MT from the second CU to the third CU.

Clause 7: The method of Clause 6, wherein at least one of the TAI or TAC is associated with a target cell of the migration of the connection of the IAB-MT from the second CU to the third CU.

Clause 8: The method of any one of Clauses 1-7, further comprising: receiving, from at least one of the second CU or the third CU, at least one of: an ID of a target cell of the second migration; or ULI of the IAB-MT.

Clause 9: The method of any one of Clauses 1-8, further comprising at least one of: acquiring a TNL address of the third CU via a SON configuration transfer; setting up an interface for connectivity with the third CU using the TNL address; or sharing a ULI of the IAB-MT with an AMF of a UE connected to the IAB node.

Clause 10: A method of wireless communication at a second CU, comprising: establishing a connection for traffic of an IAB distributed unit (IAB-DU) of an IAB node via the second CU, wherein the IAB DU has a connection to a first CU; exchanging, with a third CU, a first identifier of an IAB mobile termination (IAB-MT) in preparation of a migration of the IAB-MT from the second CU to the third CU, wherein the IAB-MT and IAB-DU are co-located in an IAB node; and providing the first identifier to the first CU.

Clause 11: The method of Clause 10, further comprising: releasing the transport of the traffic of the IAB-DU via a topology of the second CU.

Clause 12: The method of any one of Clauses 10 and 11, wherein the first identifier is allocated between the second CU and the third CU in preparation of the migration.

Clause 13: The method of any one of Clauses 10-12, further comprising: providing an identifier of the first CU to the third CU.

Clause 14: The method of any one of Clauses 10-13, further comprising: providing, to the first CU, at least one of a TAI or TAC associated with a second migration of a connection of the IAB-MT from the second CU to the third CU.

Clause 15: The method of Clause 14, wherein at least one of the TAI or TAC is associated with a target cell of the second migration.

Clause 16: The method of any one of Clauses 10-15, further comprising: providing, to the first CU, at least one of: an ID of a target cell of the second migration; or ULI of the IAB-MT.

Clause 17: A method of wireless communication at a third CU, comprising: exchanging, with a second CU, a first identifier of an integrated access and backhaul (IAB) mobile termination (IAB-MT), in preparation of a migration of the IAB-MT from the second CU to the third CU; and receiving, from a first CU, a request to migrate traffic of an IAB distributed unit (IAB-DU) to the third CU, wherein the request includes the first identifier and the IAB-MT and IAB-DU are co-located in an IAB node.

Clause 18: The method of Clause 17, wherein the first identifier is allocated between the first CU and the second CU in preparation of a previous migration.

Clause 19: The method of any one of Clauses 17 and 18, wherein the first identifier is allocated between the second CU and the third CU in preparation of the migration.

Clause 20: The method of any one of Clauses 17-19, wherein the request also includes an identifier of the second CU.

Clause 21: The method of any one of Clauses 17-20, further comprising: receiving an identifier of the first CU from the second CU, prior to receiving the request from the first CU.

Clause 22: The method of any one of Clauses 17-21, further comprising: providing, to the first CU, at least one of a TAI or TAC associated with the migration.

Clause 23: The method of Clause 22, wherein at least one of the TAI or TAC is associated with a target cell of the migration.

Clause 24: The method of any one of Clauses 17-23, further comprising: providing, to the first CU, at least one of: an ID of a target cell of the migration; or ULI of the IAB-MT.

Clause 25: An apparatus, comprising: a memory comprising executable instructions; and a processor configured to execute the executable instructions and cause the apparatus to perform a method in accordance with any one of Clauses 1-24.

Clause 26: An apparatus, comprising means for performing a method in accordance with any one of Clauses 1-24.

Clause 27: A non-transitory computer-readable medium comprising executable instructions that, when executed by a processor of an apparatus, cause the apparatus to perform a method in accordance with any one of Clauses 1-24.

Clause 28: A computer program product embodied on a computer-readable storage medium comprising code for performing a method in accordance with any one of Clauses 1-24.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication at a first centralized unit (CU), comprising:
at least one memory comprising computer-executable instructions; and one or more processors configured to execute the computer-executable instructions and cause the first CU to:
receive, from a second CU having a connection to an integrated access and backhaul (IAB) mobile termination (IAB-MT), a first identifier of the IAB-MT and a second identifier of a third CU; and
transmit, to the third CU, a request to perform a migration of traffic of an IAB distributed unit (IAB-DU) via the third CU, wherein the request includes the first identifier and the IAB-MT and IAB-DU are co-located in an IAB node.

2. The apparatus of claim 1, wherein the one or more processors are further configured to execute the computer-executable instructions and cause the first CU to communicate with the IAB node, via a topology of the second CU.

3. The apparatus of claim 1, wherein the one or more processors are further configured to execute the computer-executable instructions and cause the first CU to receive, from the third CU, an acknowledgment of the request.

4. The apparatus of claim 1, wherein the first identifier is established in preparation of a prior migration of the IAB-MT from the first CU to the second CU.

5. The apparatus of claim 1, wherein the request also includes an identifier of the second CU.

6. The apparatus of claim 1, wherein the one or more processors are further configured to execute the computer-executable instructions and cause the first CU to receive, from at least one of the second CU or the third CU, at least one of a tracking area identity (TAI) or type allocation code (TAC) associated with the migration.

7. The apparatus of claim 6, wherein at least one of the TAI or TAC is associated with a target cell of the migration of the connection of the IAB-MT from the second CU to the third CU.

8. The apparatus of claim 1, wherein the one or more processors are further configured to execute the computer-executable instructions and cause the first CU to receive, from at least one of the second CU or the third CU, at least one of:
an ID of a target cell of the migration; or
user location information (ULI) of the IAB-MT.

9. The apparatus of claim 1, wherein the one or more processors are further configured to execute the computer-executable instructions and cause the first CU to at least one of:
acquire a Transport Network Layer (TNL) address of the third CU via a self-organizing network (SON) configuration transfer;
set up an interface for connectivity with the third CU using the TNL address; or
share a user location information (ULI) of the IAB-MT with an access and mobility management function (AMF) of a UE connected to the IAB node.

10. An apparatus for wireless communication at a second centralized unit (CU), comprising:
at least one memory comprising computer-executable instructions; and one or more processors configured to execute the computer-executable instructions and cause the second CU to:
establish a connection for traffic of an IAB distributed unit (IAB-DU) of an IAB node via the second CU, wherein the IAB DU has a connection to a first CU;
exchange, with a third CU, a first identifier of an IAB mobile termination (IAB-MT) in preparation of a migration of the IAB-MT from the second CU to the third CU, wherein the IAB-MT and IAB-DU are co-located in an IAB node; and
provide the first identifier to the first CU.

11. The apparatus of claim 10, wherein the one or more processors are further configured to execute the computer-executable instructions and cause the second CU to
release the transport of the traffic of the IAB-DU via a topology of the second CU.

12. The apparatus of claim 10, wherein the first identifier is allocated between the second CU and the third CU in preparation of the migration.

13. The apparatus of claim 10, wherein the one or more processors are further configured to execute the computer-executable instructions and cause the second CU to provide an identifier of the first CU to the third CU.

14. The apparatus of claim 10, wherein the memory and the one or more processors are further configured to execute the computer-executable instructions and cause the second CU to provide, to the first CU, at least one of a tracking area identity (TAI) or type allocation code (TAC) associated with a second migration of a connection of the IAB-MT from the second CU to the third CU.

15. The apparatus of claim 14, wherein at least one of the TAI or TAC is associated with a target cell of the second migration.

16. The apparatus of claim 10, wherein the one or more processors are further configured to execute the computer-executable instructions and cause the second CU to provide, to the first CU, at least one of:
an ID of a target cell of the migration; or
user location information (ULI) of the IAB-MT.

17. An apparatus for wireless communication at a third centralized unit (CU), comprising:
at least one memory comprising computer-executable instructions; and one or more processors configured to execute the computer-executable instructions and cause the third CU to:
exchange, with a second CU, a first identifier of an integrated access and backhaul (IAB) mobile termination (IAB-MT), in preparation of a migration of the IAB-MT from the second CU to the third CU; and
receive, from a first CU, a request to migrate traffic of an IAB distributed unit (IAB-DU) to the third CU, wherein the request includes the first identifier and the IAB-MT and IAB-DU are co-located in an IAB node.

18. The apparatus of claim 17, wherein the first identifier is allocated between the first CU and the second CU in preparation of a previous migration.

19. The apparatus of claim 17, wherein the first identifier is allocated between the second CU and the third CU in preparation of the migration.

20. The apparatus of claim 17, wherein the request also includes an identifier of the second CU.

21. The apparatus of claim 17, wherein the one or more processors are further configured to execute the computer-executable instructions and cause the third CU to receive an identifier of the first CU from the second CU, prior to receiving the request from the first CU.

22. The apparatus of claim 17, wherein the one or more processors are further configured to execute the computer-executable instructions and cause the third CU to provide, to the first CU, at least one of a tracking area identity (TAI) or type allocation code (TAC) associated with the migration.

23. The apparatus of claim 22, wherein at least one of the TAI or TAC is associated with a target cell of the migration.

24. The apparatus of claim 17, wherein the one or more processors are further configured to execute the computer-executable instructions and cause the third CU to provide, to the first CU, at least one of:
an ID of a target cell of the migration; or
user location information (ULI) of the IAB-MT.

25. A method for wireless communication at a first centralized unit (CU), comprising:
receiving, from a second CU having a connection to an integrated access and backhaul (IAB) mobile termination (IAB-MT), a first identifier of the IAB-MT and a second identifier of a third CU; and
transmitting, to the third CU, a request to perform a migration of traffic of an IAB distributed unit (IAB-DU) via the third CU, wherein the request includes the first identifier and the IAB-MT and IAB-DU are co-located in an IAB node.
